(19) United States
(12) Patent Application Publication
(10) Pub. No.: US 2019/0098467 A1
(43) Pub. Date: Mar. 28, 2019

(54) WIRELESS ENVIRONMENTAL SENSOR

(71) Applicant: ShockWatch, Inc., Dallas, TX (US)

(72) Inventors: Anthony N. Fonk, Austin, TX (US); Aldric Lee, Plano, TX (US)

(21) Appl. No.: 16/137,768

(22) Filed: Sep. 21, 2018

Related U.S. Application Data
(60) Provisional application No. 62/708,022, filed on Nov. 29, 2017.
(60) Provisional application No. 62/709,445, filed on Jan. 18, 2018.
(60) Provisional application No. 62/606,417, filed on Sep. 22, 2017.

(51) Int. Cl. H04W 4/38; H04W 4/029; G06Q 10/08; H04Q 9/02

(52) U.S. Cl. CPC H04W 4/38; H04W 4/029; H04Q 2209/40; H04Q 9/02; G06Q 10/0832

(57) ABSTRACT

An environmental sensor device includes a processor unit, a monitor module for monitoring and collecting data corresponding to an environmental parameter, a radio module configured to enable wireless communication of the data to a remote system, and logic executable by the processor unit to convert the collected data into an unstructured supplementary service data (USSD) message. The radio module is configured to transmit the USSD message to a remote data processing system.

### BACKGROUND

Environmental sensing devices and/or monitoring devices may be used to sense, monitor, log, and report various types of environmental parameters (e.g., shock or vibration events, temperature, geographic location, etc.). Oftentimes, such devices may be attached to or otherwise associated with a mobile object (e.g., a package traveling by ground, water, air, etc.). For example, the environmental device may be affixed to a package in need of temperature control such that the environmental device detects and logs temperature values corresponding to its environment throughout the transport of the package, thereby enabling a verification of the environment the package was subjected to while in transit.

### BRIEF SUMMARY

According to one aspect of the present disclosure, a wireless environmental sensor or monitoring device includes a processor unit, a monitor module for monitoring and collecting data corresponding to an environmental parameter, and a radio module configured to enable wireless communication of the data to a remote system. The device also includes logic executable by the processor unit to convert the collected data into an unstructured supplementary service data (USSD) message and transmit the USSD message to a remote data processing system.

According to another embodiment of the present disclosure, a method and technique for wireless environmental monitoring includes monitoring and collecting, by an environmental sensor device, data corresponding to an environmental parameter. The environmental sensor device converts the collected data into an unstructured supplementary service data (USSD) message and wirelessly communicates the USSD message from the environmental sensor device to a remote data processing system.

According to yet another embodiment of the present disclosure, a wireless environmental monitoring or sensor device includes a processor unit, a monitor module configured to monitor and collect data corresponding to an environmental parameter, and a radio module configured to enable wireless communication of the data to a remote system. The device also includes logic executable by the processor unit to create a blockchain of the collected data and wirelessly communicate the blockchain of the collected data to a remote data processing system.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a wireless environmental sensor device in a communication network in which illustrative embodiments of the present disclosure may be implemented;

FIG. 4 is a diagram illustrating an embodiment of a wireless environmental sensor device in which illustrative embodiments of the present disclosure may be implemented;

FIG. 5 is a flow diagram illustrating an embodiment of a method for wireless environmental parameter monitoring according to the present disclosure; and

FIG. 6 is a flow diagram illustrating another embodiment of a method for wireless environmental parameter monitoring according to the present disclosure.

### DETAILED DESCRIPTION

Embodiments of the present disclosure provide a wireless environmental monitoring or sensor device that monitors one or more environmental parameters and wirelessly communicates data related to the monitored environmental parameters to a remote data processing system (e.g., to one or more remote servers). In some embodiments, the device communicates the collected environmental data via unstructured supplementary service data (USSD) messages to a remote system/network, thereby providing a real-time communication of environmental parameter data at a reduced cost. In some embodiments, the device can blockchain the data to provide greater security and reliability of the monitored environmental parameters.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

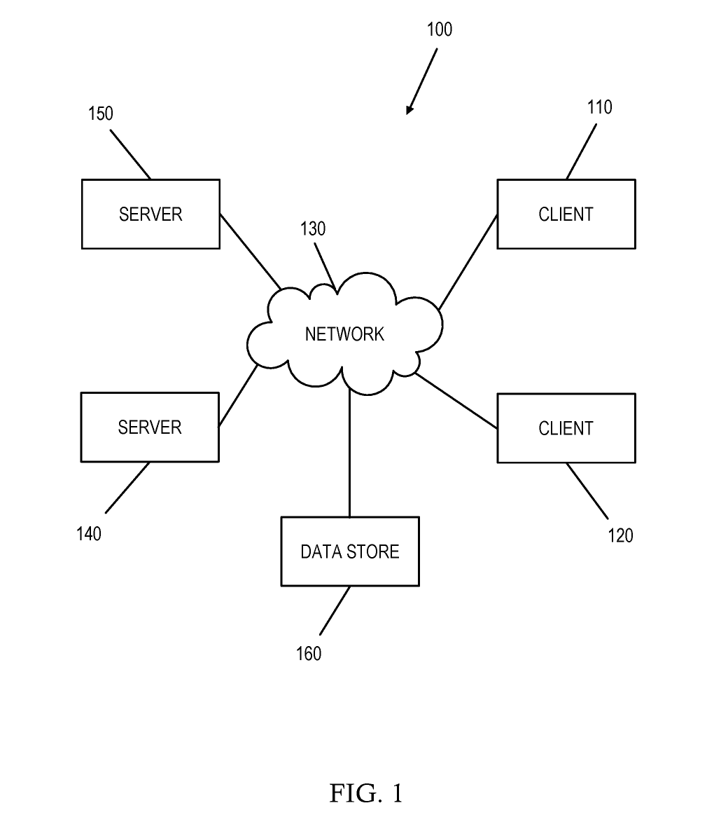

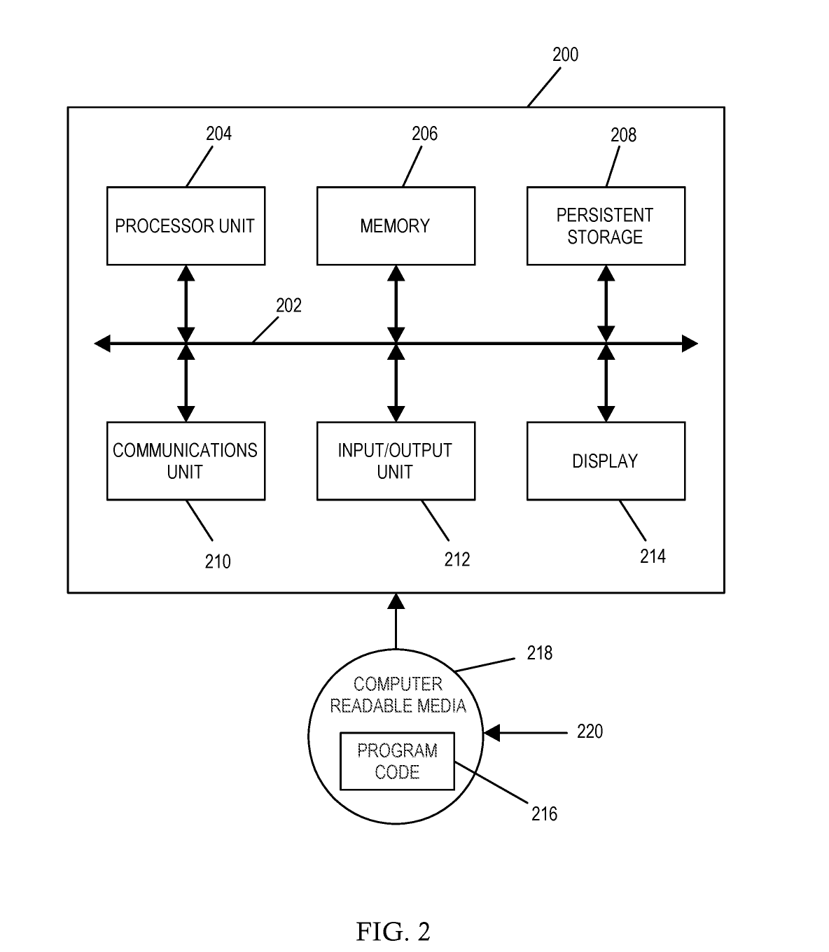

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a system for wireless environmental sensor communications according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

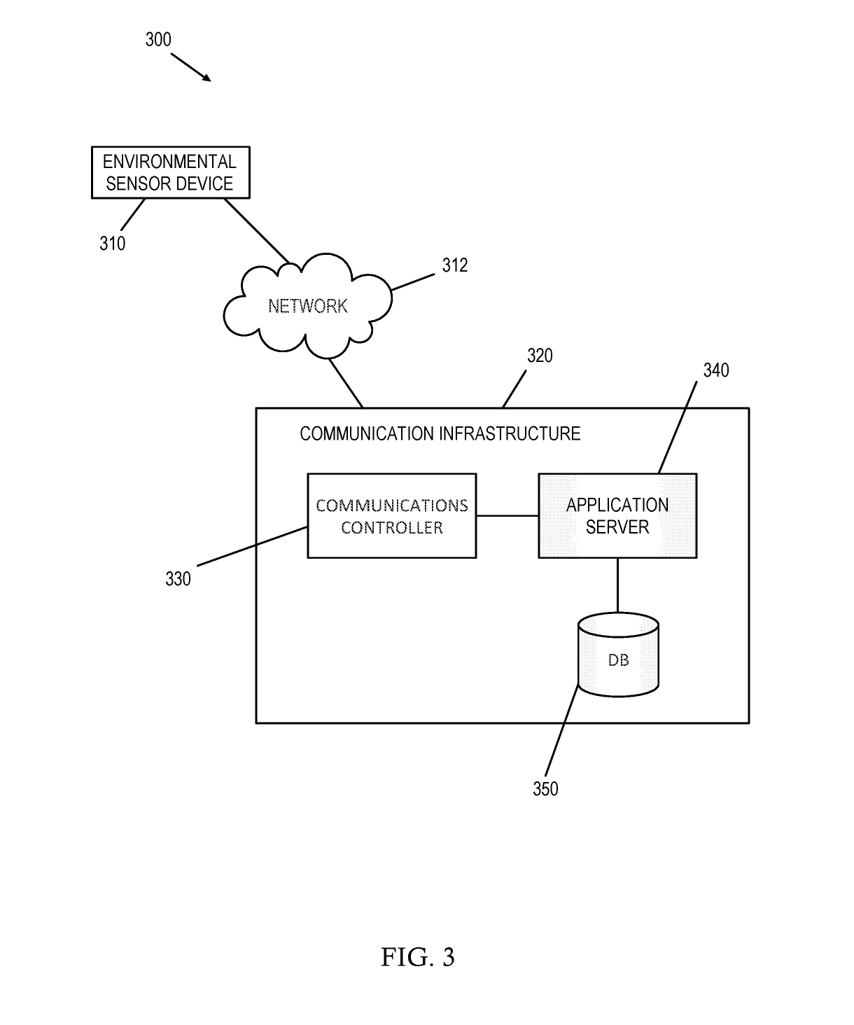

FIG. 3 is a diagram illustrating an embodiment of a system 300 for wireless environmental sensor communications in which illustrative embodiments of the present disclosure may be implemented. In the embodiment illustrated in FIG. 3, system 300 includes an environmental sensor device 310 that is communicatively coupled to a network 312, which in turn is communicatively coupled to a communication infrastructure 320. Device 310 is configured to monitor, store, and/or log one or more environmental parameters encountered or experienced by an object to which it is attached, mounted, or otherwise associated. For example, device 310 may comprise a shock sensor, temperature sensor, humidity sensor, chemical sensor, radiation sensor, or a combination thereof, or other type of sensor for monitoring a desired environmental parameter(s) and/or recording/storing/logging values corresponding to the monitored parameter(s). Device 310 may be a passive monitor/indicator (e.g., remaining in a non-activated state until a sufficient magnitude of an environmental event is detected, thereby utilizing little or no power (e.g., containing a passive RFID tag, etc.)) or an active monitor/indicator (e.g., measuring/recording/storing/logging values corresponding to the monitored parameter(s) continuously, at certain intervals, etc.). In some embodiments, a passive device 310 may be “awoke” or triggered to perform various functions as described herein in response to an activation of the indicator (e.g., sensing or detecting a sufficient level or magnitude of a monitored environmental parameter, being energized by an RFID reader, etc.).

Network 312 is a mobile communications network to facilitate communications between device 310 and infrastructure 320. For example, network 312 may be configured according to Global System for Mobile Communications (GSM) standards for supporting the transmission of information over GSM networks, configured for communications using Universal Mobile Telecommunications Systems (UMTS) technologies, configured according to long-term evolution (LTE) standards, configured according to code-division multiple access (CDMA) standards, etc. Thus, it should be understood that network 312 may be any type of mobile communications network or infrastructure for supporting wireless communications (which may also include a wireless local area network, personal area network, and/or wired networks).

Infrastructure 320 comprises devices and/or networks that enable communications to be made to/from device 310 (e.g., switches, servers, storage devices, and networks (e.g., wireless networks, the Internet, landline telephone networks, etc.)). In the illustrated embodiment, infrastructure 320 includes a communications controller 330 communicatively coupled to an application server 340, and application server 340 is communicatively coupled to a memory or storage device such as a database 350. As will be described in greater detail below, infrastructure 320 facilitates the use of unstructured supplementary service data (USSD) messages to obtain environmental parameter data/values from device 310. Embodiments of the present invention enable the transmission of environmental parameter data measured/recorded by device 310 to be communicated over the signaling channels of the communications network.

For example, USSD enables text-based interactions between applications (e.g., an application residing on application server 340) and device 310. A USSD message may be initiated by the network (e.g., infrastructure 320) or device 310. In network initiated USSD messages, the network may request information from device 310 (e.g., a “pulling” request). USSD messages may contain a service code that identifies the action to be taken on receipt of the USSD message. The service code may include digits, letters, and/or signs. For example, a USSD code may be any code string beginning with *, **, or ***, or #, or ##, or ###, or any combination of asterisks (*) and pound characters (#) up to three digits long, and with other codes, and which terminates with a # sign. In operation, for example, device 310 may receive the code and, based on the particular code, perform some action (e.g., initiate the transfer of parameter value data via USSD messages to application server 340). In a device initiated USSD message, device 310 may be configured to initiate a communication of parameter value data via USSD messages to application server 340 according to a variety of different protocols (e.g., after queuing a certain amount of data or number of readings, at certain time intervals, after a threshold has been reached or alarm has been generated, etc.). Application server 340 and/or database 350 may be configured to translate or convert the USSD messages to certain data values for storage in database 350.

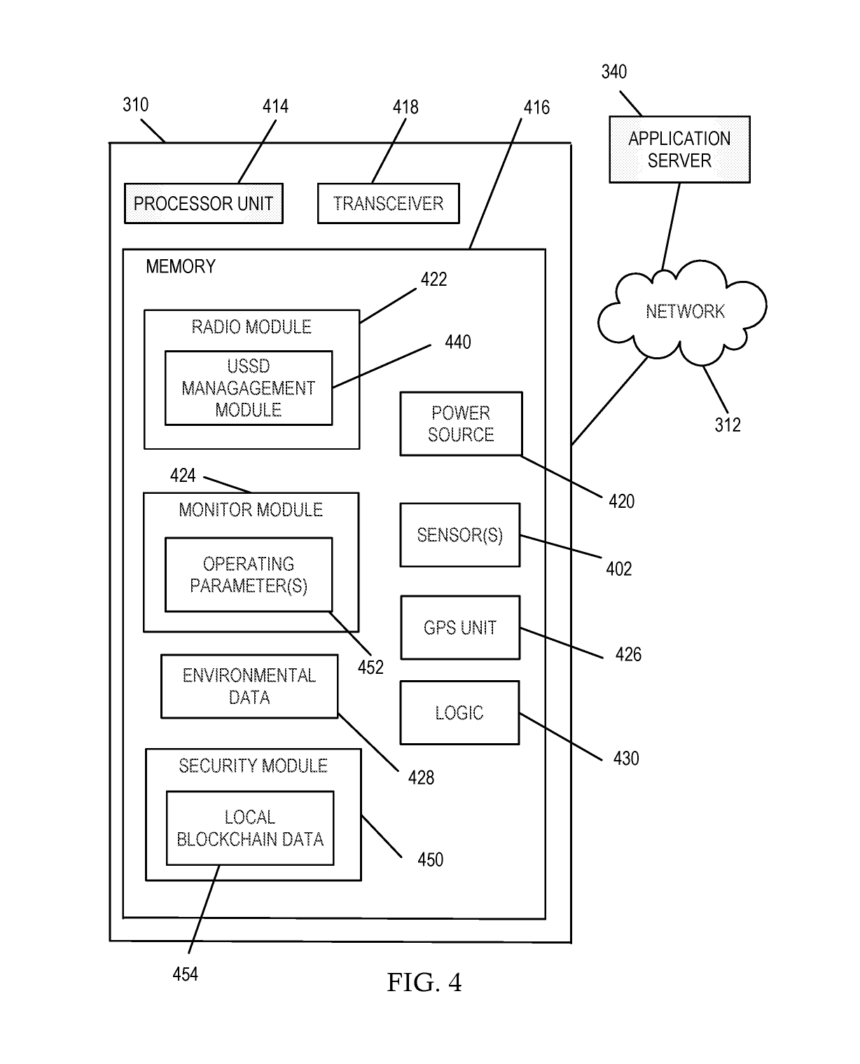

FIG. 4 is a diagram illustrating an embodiment of environmental sensor device 310 in accordance with the present disclosure. In the embodiment illustrated in FIG. 4, device 310 comprises a data processing system having a processor unit 414, a storage resource or memory 416, a transceiver 418, and a local or onboard power source 420. Device 310 also includes one or more environmental sensors 402 for detecting and/or monitoring various environmental parameters (e.g., shock sensor, temperature sensor, humidity sensor, etc.). Transceiver 418 may be used to facilitate wireless communications between device 310 and other systems/devices (e.g., application server 340). Power source 420 may comprise a battery located on, within, and/or otherwise configured as part of device 310 for supplying power to various operational components of device 310. In the embodiment illustrated in FIG. 4, memory 416 comprises a radio module 422 having a USSD management module 440, a monitor module 424, a GPS unit 426, environmental data 428, and logic 430. In FIG. 4, radio module 422, USSD management module 440, monitor module 424, and logic 430 are illustrated as a software program residing in memory 416 and executable by processor unit 414. However, it should be understood that radio module 422, USSD management module 440, monitor module 424, and/or logic 430 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

Radio module 422 performs various operations associated with wireless communications between device 310 and other devices and/or systems (e.g., network 312 and/or application server 340). For example, in the embodiment illustrated in FIG. 4, device 310 may communicate wirelessly with other remote data processing systems (e.g., communicating data to application server 340). Radio module 422 may include a subscriber identity module (SIM) card and/or other hardware/software to facilitate the wireless communications described herein. Monitor module 424 performs various operations associated with the environmental parameter monitoring operations and processes performed by device 310. For example, monitor module 424 may be configured to cause device to monitor, store and/or analyze various environmental sensor input signals associated with sensor(s) 402 and store such parameter data as environmental data 428, which may include time-stamped data entries and/or other types of data inputs.

In the illustrated embodiment, radio module 422 includes USSD management module 440. USSD management module 440 performs various USSD-related messaging operations in connection with device 310. For example, management module 440 may receive a data pulling operation message from application server 340 and initiate a data push operation in response thereto via USSD messages. Management module 440 may also initiate a data pushing operation to transmit environmental parameter data to application server 340 via USSD messages.

Logic 430 may be used to perform various monitoring functions and cause certain functions of device 310 to be invoked or ceased based on the monitored conditions, based on received USSD messages, based on a location of device 310, etc. In the illustrated embodiment, logic 430 is depicted separate and apart from radio module 422 and monitor module 424; however, it should be understood that various functions, code, and/or circuitry associated with logic 430 may be incorporated in and/or be part of radio module 422 and/or monitor module 424 (and transceiver 418). In some embodiments, logic 430 is configured to convert environmental data 428 to USSD coded messages, determine when to communicate environmental data 428 to application server 340, etc.

For example, devices that communicate over cellular or other types of wireless networks offer many advantages, such as mobility. As a device travels from one geographic region to another (e.g., leaving a home network and traveling to a non-local or non-home network), the device can connect to a local network and continue communicating using such connected network, often called roaming. For example, roaming service is generally provided between telecommunication carriers where devices (e.g., cellular devices) can connect to a base station corresponding to a service area provided by a telecommunication carrier other than the telecommunication carrier to which the cellular device belongs (e.g., in a geographical area not served by a subscriber's home network). As a result, cellular devices can connect to base stations belonging to a telecommunication carrier in foreign countries. However, the cost associated with roaming communications can vary from one geographic region to another, and such roaming costs can be excessive.

Global communication systems offer services to mobile, computer and/or phone users throughout the world. Users roaming in areas, serviced by carriers that are not their home-based contracted carrier, rely on roaming architecture standards in order to roam. The architecture defines how services can be obtained and how data packets can be routed to and/or from the home carrier network. Typically, the process starts with a user attaching to a roaming network's network. For example, when a wireless electronic device is turned on or travels from one geographic region to another, a process known as autonomous registration occurs. The wireless device transmits a unique identifying data stream to the nearest base station of the local wireless system. The base station adds its unique cell/sector identification number to the autonomous registration data stream and sends the information to a mobile switching center. The mobile switching center determines whether the device is a local user or whether it is a foreign user (i.e., roaming). The device is then verified and authorized to communicate (e.g., via communications established between the local and home networks).

In some embodiments of the present disclosure, GPS unit 426 may be used to determine a geographic location of device 310. Based on the geographic location of device 310, logic 430 may be configured to initiate a transfer of environmental data 428 to application server 340 via USSD messages. For example, as device 310 moves from one location to another (e.g., along a supply chain route), logic 430 may be configured to initiate a communication of environmental data 428 that has been monitored/recorded via sensor(s) 402 upon device 310 reaching certain locations/destinations. In some embodiments, application server 340 may push a USSD message to device 310 inquiring as to the geographic location of device 310. In response, based on data from GPS unit 426, a USSD message may be communicated to application server 340 with the requested geographic location information. If the geographic location information meets some designated criteria, application server 340 may initiate a data pull operation from device via USSD messages (a pull request and corresponding data transfer).

Logic 430 may also be configured to initiate a communication of environmental data 428 that has been monitored/recorded via sensor(s) 402 in response to certain configuration or operating parameters. For example, monitor module 424 may include one or more operating parameters 452 corresponding to the type(s) of environmental parameters being measured/monitored/recorded. Operating parameters 452 may include, for example, alarm thresholds, wake up thresholds, drop out thresholds, sample/reading intervals/thresholds, etc. In some embodiments, if a particular operating parameter 452 has been met, logic 430 may initiate a transfer of environmental data 428 to application server 340 via USSD messages. Thus, for example, if an impact event meets or exceeds a particular alarm threshold, logic 430 may initiate a transfer of environmental data 428 to application server 340 via USSD messages. As another example, logic 430 may initiate a transfer of environmental data 428 to application server 340 via USSD messages after a certain quantity of readings have been made/stored and/or at certain time intervals.

Thus, in some embodiments, logic 430 may cause device 310 to operate solely in a monitoring or “sleep” mode such that instructions and/or communications associated with the transfer of environmental data 428 to application server 340 are suspended, thereby resulting in a reduced power consumption by device 310. As indicated above, in some embodiments, certain operating parameters 452 may be set (e.g., by a user). For example, an alarm threshold for an accelerometer type of sensor 402 may be a minimum value of an impact magnitude on the x, y or z axis that will trigger an outbound alarm USSD message to application server 340. The threshold value for each axis may be independent. A wake up threshold may be a setting that determines when the accelerometer comes out of sleep mode (sampling at one rate) and begins sampling at a second, increased rate (e.g., a rate of 1024 samples per second). This setting may automatically be calculated as a function of the alarm threshold. A drop out threshold may be a setting for determining when the accelerometer returns to the sleep mode sampling rate. This setting may also be automatically be calculated as a function of the alarm threshold. It should be understood that the types of operating parameters 452 may vary based on the type of sensor 402.

Thus, an alarm status can be beneficial in alerting users to particular environmental conditions that may require attention. In some embodiments, it may be desirable for device 310 to store the environmental event data 428 for first alarm event. In other embodiments, it may be desirable for device 310 to store a certain quantity of the largest magnitude events (e.g., the fifty largest magnitude acceleration values). Environmental event data 428 may include some or all of the following: 1) time and date of event; 2) value of the event; 3) if an acceleration event, the axis on which the primary acceleration occurred; 4) if an acceleration event, the acceleration values as measured on the other two axes; and 5) the modulus of the event. Device 310 may be configured to use the absolute value of the acceleration magnitudes for the purpose of filtering the fifty largest magnitude events. The axis for the primary acceleration may be reported with its +/− sign so as to provide information on the direction of the acceleration. In some embodiments, certain environmental data 428 may be purged, erased, or overwritten (e.g., lower values) once an excess of fifty events have been recorded. It should be understood that the type of environmental event data 428 that is measured/stored may vary based on the type of sensor 402 and/or environmental parameter being measured.

As discussed above, when an operating parameter 452 has been met with respect to a measured environmental parameter, logic 430 may coordinate with radio module 422 to send an outbound USSD wireless message to application server 430 (e.g., a single value, multiple values, or a series of values for some predetermined amount of time). The USSD message may contain information such as the following: 1) a unique identifier associated with the particular device 310 and/or a unique identifier assigned to or otherwise associated with an object to which device 310 is associated; 2) time and date of the event; 3) event value (e.g., magnitude of the acceleration along with primary axis of acceleration if an acceleration event); 4) other related values (e.g., corresponding acceleration values for the other two axes along with axis identifications if an acceleration event); 5) cell ID of the three cell towers with the largest received signal strength indicator (RSSI) values; and 6) RSSI values of each cell ID. It should be understood that the content of the USSD message may vary based on the type environmental data 428 being communicated. The unique identifier associated with the particular device 310 and/or the unique identifier assigned to or otherwise associated with an object to which device 310 is associated may be such that it/they are readable or in some manner ascertainable while device 310/object moves through a travel route (e.g., via a bar code scanner, photographic image, RFID reader (e.g., device 310/object having associated therewith an RFID tag), etc.).

In some embodiments, logic 430 may utilize a threshold-driven timeslot summarization feature. For example, a user programmable timeslot threshold may be utilized and may be set above some minimum threshold. Timeslot periods may be programmable between a range of various times (e.g. between twenty minutes and one hour). If an acceleration event, for example, exceeds the timeslot threshold, that value may then be compared to the maximum timeslot value for the particular timeslot. Logic 430 may maintain the maximum value on each axis for each timeslot. At the end of the timeslot, the maximum value for each axis may be stored and/or communicated and a new timeslot may be started.

Additionally, in some embodiments, logic 430 utilizes histograms with bin counters. For example a histogram using the following parameters may be used: 1) 200 G scale−bin width=4 G, total bin=50; 2) 100 G scale−bin width=2 G, total bins=50; 3) 30 G scale−bin width=0.5 G, total bin=60; and 4) 10 G scale−bin width=0.2 G, total bins=50. Specific bin counter values may in some embodiments be incremented as a result of the peak values measured when a minimum store threshold is exceeded.

In some embodiments, logic 430 is configured to send an outbound summary USSD message at a user specified interval (e.g., every hour, every twelve hours, etc.). The summary message may contain some or all of the following types of information: 1) ID of device 310; 2) message timestamp; 3) maximum value for each axis; 4) number of alarms generated; 5) cell ID of the three cell towers with the largest RSSI values; 6) RSSI values of each cell ID; and 7) histogram bin counter values.

In the embodiment illustrated in FIG. 4, device 310 also includes a security module 450. Security module 450 performs various security functions associated with environmental data 428. For example, in some embodiments, security module 450 may perform various hashing and/or cryptographic functions to create a blockchain of environmental data 428 measured/recorded/stored by device 310. For example, in some embodiments, security module 450 may create an initial piece of blockchain data (e.g., using a unique identifier (ID) of device 310, a unique identifier assigned to or otherwise associated with an object to which device 310 is associated, manufacturer/provider information of device 310 and/or the object to which device 310 is associated, etc.) and digitally sign the initial piece of blockchain data with a private key. The initial piece of blockchain data may be stored locally on device 310 (e.g., as local blockchain data 454) and/or communicated/stored remotely (e.g., by application server 340 and/or other or additional remote locations usable as a shared ledger). As environmental data 428 is sensed/measured/recorded/etc. via sensor(s) 402, one or more pieces of environmental data 428 transactions (a single occurrence and/or a series or block of environmental data 428) may be added to the blockchain. For example, at periodic intervals, after some amount of collected environmental data 428 occurs, upon a detection of a recorded incident/event, upon meeting a particular operating parameter 452, upon reaching a particular geographic location, etc., a hash of the initial blockchain data may be added to the current piece or block of environmental data 428 to create a second piece of blockchain data. The second piece of blockchain data (which may also include a timestamp and/or geographic location data if not already included in environmental data 428) may be digitally signed and be stored locally (e.g., as additional local blockchain data 454) and/or may be communicated via USSD messages to application server 340 and/or additional remote locations (or communicated via USSD messages in response to receiving a USSD pull message). The current piece of blockchain data may be verified (e.g., at application server 340 and/or other remote locations) using a public key (e.g., of the manufacturer or provider of device 310) and/or verified with prior pieces of blockchain data. If any block in the blockchain is not valid, an error message may be generated indicating the invalid block. In some embodiments, the transmitted environmental data 428 may be encrypted (e.g., before blockchaining, after blockchaining, etc.) such that a receiver of the data decrypts the encrypted information with a corresponding key.

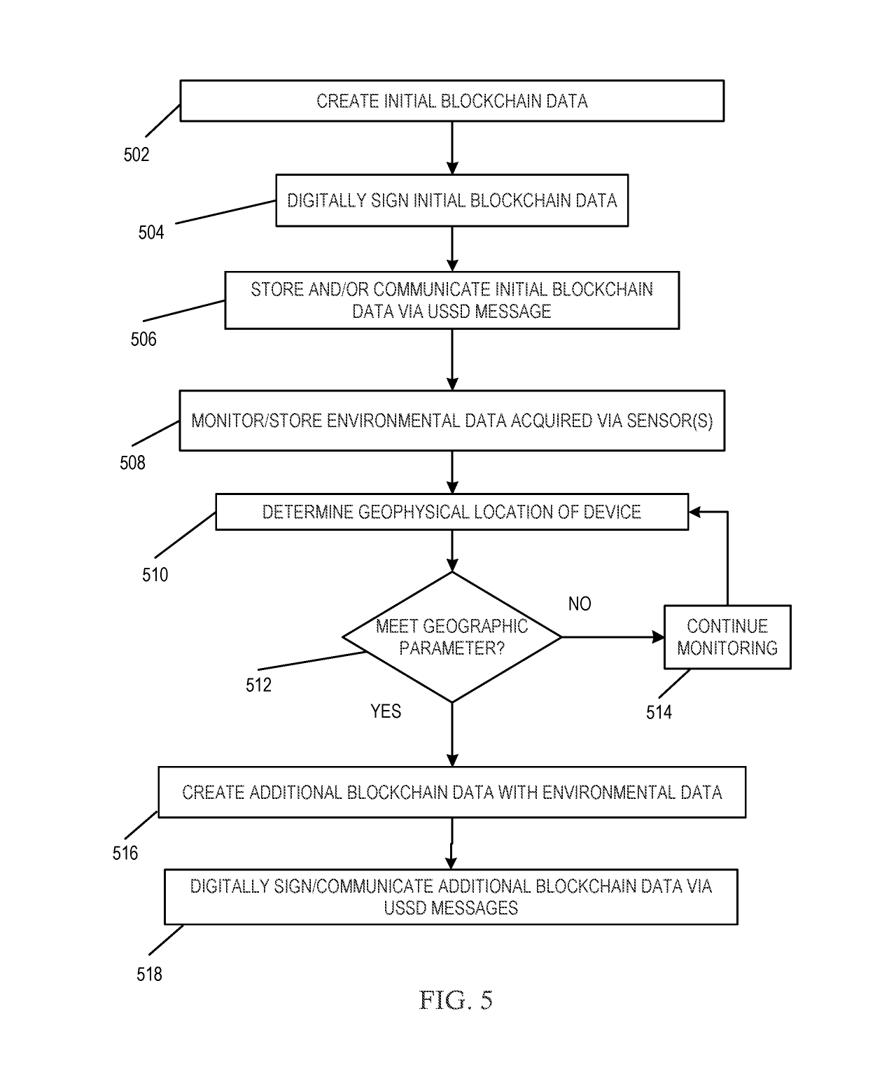

FIG. 5 is a flow diagram illustrating an embodiment of a method for impact indicator monitoring. The method begins at block 502, an initial piece of blockchain data is created. For example, security module 450 may create an initial piece of blockchain data using a unique identifier (e.g., a serial number) assigned to device 310, a unique identifier assigned to a package or object to which device 310 is associated, information pertaining to a manufacturer/provider of device 310, etc. At block 504, module 450 may digitally sign the initial piece of blockchain data (e.g., using a private key associated with a manufacturer/provider of device 310, package or object to which device 310 is associated, etc.). At block 506, security module 450 stores the initial piece of blockchain data as local blockchain data 454. At block 508, device 310 monitors/stores environmental data 428 acquired via sensors 402. At block 510, logic 430 may interface with GPS unit 426 to determine a geographic location of device 310. At decisional block 512, logic 430 determines whether a geographic location of device 310 meets a particular geographic parameter. For example, as indicated above, logic 430 may be configured to cause acquired environmental data 428 to be communicated or transmitted to application server 340 based on the geographic location of device 310 (e.g., after a certain distance has been traveled, after movement across a geographical border/boundary, upon arriving at a certain destination, etc.). If so, the method proceeds to block 516, where logic 430 may interface with security module 450 to create an additional piece of blockchain data (e.g., based on or using recently acquired environmental data 428). At block 518, logic 430 may interface with USSD management module 440 to cause the newly created piece of blockchain data to be communicated to application server 340 via USSD messages. If at decisional block 512 it is determined that a geographic location of device 310 does not meet some particular geographic parameter indicator, the method proceeds from decisional block 512 to block 514, where logic 430 may continue monitoring (e.g., at some interval) the geographic location of device 310.

In the above description in connection with FIG. 5, the data communicated to application server 340 is described as blockchain data. However, it should be understood that in some embodiments, blockchaining of data may be omitted or not performed. For example, in one such embodiment, environmental data 428 itself (with or without being digitally signed) may be transmitted.

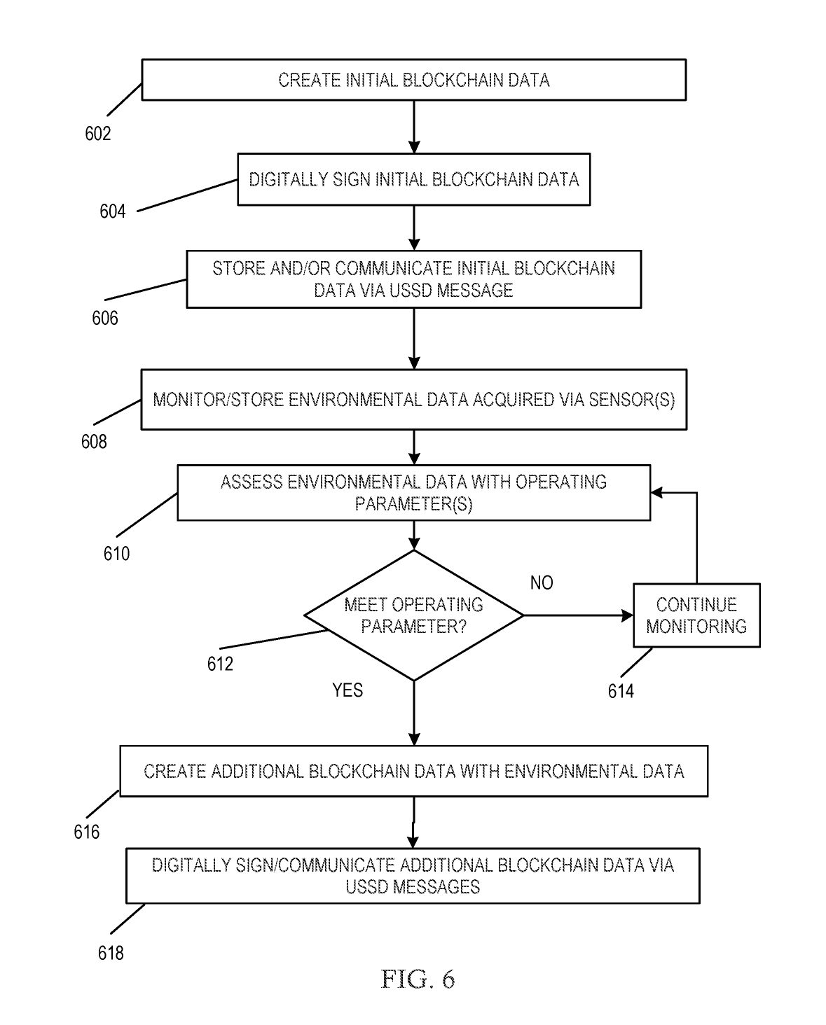

FIG. 6 is a flow diagram illustrating an embodiment of a method for impact indicator monitoring. The method begins at block 602, an initial piece of blockchain data is created. For example, security module 450 may create an initial piece of blockchain data using a unique identifier (e.g., a serial number) assigned to device 310, a unique identifier assigned to a package or object to which device 310 is associated, information pertaining to a manufacturer/provider of device 310, etc. At block 604, module 450 may digitally sign the initial piece of blockchain data (e.g., using a private key associated with a manufacturer/provider of device 310, package or object to which device 310 is associated, etc.). At block 606, security module 450 stores the initial piece of blockchain data as local blockchain data 454. At block 608, device 310 monitors/stores environmental data 428 acquired via sensors 402. At block 610, logic 430 may interface with monitor module 424 to assess environmental data 428 in connection with one or more operating parameters 452. For example, as described above, operating parameters 452 may correspond to the type(s) of environmental parameters being measured/monitored/recorded by device 310/sensor(s) 402. Operating parameters 452 may include, for example, alarm thresholds, wake up thresholds, drop out thresholds, sample/reading intervals/thresholds, etc. At decisional block 612, logic 430 determines whether detected environmental data 428 has met an operating parameter. If so, the method proceeds to block 616, where logic 430 may interface with security module 450 to create an additional piece of blockchain data (e.g., based on or using recently acquired environmental data 428). At block 618, logic 430 may interface with USSD management module 440 to cause the newly created piece of blockchain data to be communicated to application server 340 via USSD messages. If at decisional block 612 it is determined that an operating parameter 452 has not been met, the method proceeds from decisional block 612 to block 614, where logic 430 may continue monitoring (e.g., at some interval) the environmental data 428 in connection with the respective operating parameters 452.

In the above description in connection with FIG. 6, the data communicated to application server 340 is described as blockchain data. However, it should be understood that in some embodiments, blockchaining of data may be omitted or not performed. For example, in one such embodiment, environmental data 428 itself (with or without being digitally signed) may be transmitted.

Thus, embodiments of the present disclosure enable environmental parameter monitoring via a device that can collect data corresponding to the environmental parameter and communicate that data in real time via USSD messages. In some embodiments, various conditions can trigger the communication of the USSD messages from the monitoring device, such as receiving a “pull” message (or a push request) from an application server, in based on a geographic location of the device, based on a measured parameter meeting a threshold, based on collecting a certain quantity of readings, at certain time intervals, etc. Additionally, embodiments of the device may blockchain the collected data to provide greater security for the measured/monitored data (thereby further preventing the possibility of data tampering).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An environmental sensor device, comprising:
a processor unit;
a monitor module for monitoring and collecting data corresponding to an environmental parameter;
a radio module configured to enable wireless communication of the data to a remote system; and
logic executable by the processor unit to:
convert the collected data into an unstructured supplementary service data (USSD) message; and
transmit the USSD message to a remote data processing system.

2. The device of claim 1, wherein the logic is executable to blockchain the collected data.

3. The device of claim 1, wherein the logic is executable to receive a USSD pull message from an application server and communicate the collected data via the USSD message.

4. The device of claim 1, wherein the logic is executable to communicate the USSD message in response to determining that the device is in a particular geographic location.

5. The device of claim 1, wherein the logic is executable to communicate the USSD message in response to the collected data meeting a particular operating parameter.

6. The device of claim 1, wherein the logic is executable to create a piece of blockchain data based on a unique identifier assigned to the device.

7. The device of claim 6, wherein the logic is executable to digitally sign the piece of blockchain data.

8. A method, comprising:
monitoring and collecting, by an environmental sensor device, data corresponding to an environmental parameter;
converting, by the environmental sensor device, the collected data into an unstructured supplementary service data (USSD) message; and
wirelessly communicating the USSD message from the environmental sensor device to a remote data processing system.

9. The method of claim 8, further comprising blockchaining the collected data.

10. The method of claim 8, further comprising, responsive to receiving a USSD pull message from an application server, communicating the collected data via the USSD message.

11. The method of claim 8, further comprising communicating the USSD message in response to determining that the device is in a particular geographic location.

12. The method of claim 8, further comprising communicating the USSD message in response to the collected data meeting a particular operating parameter.

13. The method of claim 8, further comprising creating a piece of blockchain data based on a unique identifier assigned to the device.

14. The method of claim 13, further comprising digitally signing the piece of blockchain data.

15. An environmental sensor device, comprising:
a processor unit;
a monitor module configured to monitor and collect data corresponding to an environmental parameter;
a radio module configured to enable wireless communication of the data to a remote system; and
logic executable by the processor unit to:
create a blockchain of the collected data; and
wirelessly communicate the blockchain of the collected data to a remote data processing system.

16. The device of claim 15, wherein the wherein the logic is executable to create a piece of the blockchain of the collected data incorporating a unique identifier of the device.

17. The device of claim 15, wherein the logic is executable to incorporate a geographic location of the device into the blockchain of the collected data.

18. The device of claim 15, wherein the logic is executable to wirelessly communicate the blockchain of the collected data via an unstructured supplementary service data (USSD) message.

19. The device of claim 15, wherein the logic is executable to communicate the blockchain of the collected data in response to determining that the device is in a particular geographic location.

20. The device of claim 15, wherein the logic is executable to communicate the blockchain of the collected data in response to a monitored environmental parameter meeting a threshold.
